(19) United States
(12) Patent Application Publication
(10) Pub. No.: US 2003/0115036 A1
(43) Pub. Date: Jun. 19, 2003

(54) Software-based method for simulation of multiple access networks

(75) Inventor: Bird H.W. Chen, Taipei (TW)

Correspondence Address: BACON & THOMAS, PLLC, 625 SLATERS LANE, FOURTH FLOOR, ALEXANDRIA, VA, 22314

(73) Assignee: Institute for Information Industry, Taipei (TW)

(21) Appl. No.: 10/067,277

(22) Filed: Feb. 7, 2002

(30) Foreign Application Priority Data
Dec. 19, 2001 (TW) 90131541

(51) Int. Cl. G06F 9/44

(52) U.S. Cl. 703/21

(57) ABSTRACT

A software-based method for simulation of multiple access networks is provided. The method can simulate one or more networks complying with broadcast media on one or more computers installed with a protocol for transferring simulation frames to computers involved in simulation by using software. Also, simulation frames are transferred over the simulated network. The invention takes advantage of the installed protocol to simulate a frame transfer mechanism. Further, the invention can define and simulate a real network topology by software for transmitting/receiving simulation frames.

### BACKGROUND OF THE INVENTION

1. Field of the Invention

The present invention relates to a method for accessing to network and, more particularly, to a software-based method for simulation of multiple access networks.

2. Description of Related Art

Conventionally, an Internet protocol is implemented in an existing network (e.g., Ethernet) which is responsible for communicating information. Further, a topology of the network is established to configure communication parameters of a network layer. Network topology is an arrangement of computers, cables, and other branches in a network wherein computers are interconnected for enabling a sharing of resources among them. For obtaining an optimum operation, the topology should be programmed depending on applications. A typical topology falls into one of the following four types:

Bus: It means that each of a plurality of devices (e.g., computers) is coupled to one or more common cables which are the coupled to together.

Star: It means that each of a plurality of computers is coupled to the other computer by cable via a hub.

Ring: It means that a ring is formed by a plurality of computers coupled by cable.

Mesh: It means that any two adjacent computers are coupled together by a unique cable.

However, any above topology is implemented by manually interconnecting cables prior to configuring hardware and/or software. As understood, that manual processing is time consuming and prone to err. Hence, employees have to spend much time on debugging non-critical errors. For example, in the case of interconnecting five computers by adding two computers into the already connected three computers, a disconnection of the established network is possible due to a human error in wiring. In another case of establishing a new Internet protocol, it is necessary to re-program the wiring of network for forming a new network topology for tailoring the needs of experiment or teaching. But above redesign is undesirable because of limited space, inadequate equipment, large scale network layout, high cost, and inflexible network topology.

Therefore, it is desirable to provide a novel method for accessing to network in order to mitigate and/or obviate the aforementioned problems.

### SUMMARY OF THE INVENTION

An object of the present invention is to provide a software-based method for simulation of multiple access networks so that a purpose of simulating network topology by software is achieved.

Another object of the present invention is to provide a software-based method for simulation of multiple access networks so that both troubles caused by human errors and time spend by manual wiring are reduced significantly.

Still another object of the present invention is to provide a software-based method for simulation of multiple access networks so that cost of both labor and procurement is reduced significantly.

To achieve the object, the software-based method for simulation of multiple access networks of the present invention comprises a data conversion procedure, a computer-played simulator procedure, a first validation procedure, a second validation procedure, a transmitting simulation frame procedure, a receiving simulation frame procedure, and a software simulation network configuration procedure wherein the data conversion procedure is responsible for converting network configuration information into a data type that is identifiable by a computer and storing the same in a rewritable data storage device which is capable of distributing data into respective computers; the computer-played simulator procedure is responsible for retrieving contents of the rewritable data storage device and following a logic operation based on the contents, so as to act as a simulator for simulating nodes in a network; the first validation procedure is responsible for validating an integrity of network configuration; the second validation procedure is responsible for validating a symmetry of network configuration; the transmitting simulation frame procedure is responsible for transmitting simulation frames to a receiving simulator, wherein the simulation frame is implemented as a data structure capable of communicating among nodes; the receiving simulation frame procedure is responsible for determining whether the received simulation frames are valid or not; and the software simulation network configuration procedure is responsible for establishing a network configuration to be simulated based on above procedures.

Other objects, advantages, and novel features of the invention will become more apparent from the detailed description when taken in conjunction with the accompanying drawings.

### BRIEF DESCRIPTION OF THE DRAWINGS

FIG. 1 presents schematically a network topology simulated by software according to the invention;

FIG. 2 presents schematically a relationship among elements of a rewritable data storage device according to the invention;

FIG. 3 is a flow chart illustrating a data conversion procedure according to the invention;

FIG. 4 is a flow chart illustrating a first validation procedure according to the invention;

FIG. 5 is a flow chart illustrating a second validation procedure according to the invention;

FIG. 6 is a flow chart illustrating a transmitting simulation frame procedure according to the invention;

FIG. 7 is a flow chart illustrating a receiving simulation frame procedure according to the invention; and

FIG. 8 is a flow chart illustrating a software simulation network configuration procedure according to the invention.

### DETAILED DESCRIPTION OF THE PREFERRED EMBODIMENT

In a preferred embodiment of the invention, a broadcast packet switching network (e.g., Ethernet, or the like) is simulated. The invention can simulate one or more networks complying with broadcast medium on one or more computers installed with a protocol (e.g., TCP/IP (Transport Control Protocol/Internet Protocol) for transferring simulation frames to computers involved in the simulation) by using software. Also, simulation frames are transferred over the simulated network. The invention takes advantage of the installed protocol to simulate a frame transfer mechanism. Further, the invention can define and simulate a real network topology by software for transmitting/receiving simulation frames. As a result, a simulation of multiple access networks is effected.

A computer employed by the invention comprises a rewritable data storage device for storing data about the network topology and associated parameters. Data may be object-oriented, relation-oriented, or the other as long as it can correctly represent the network topology.

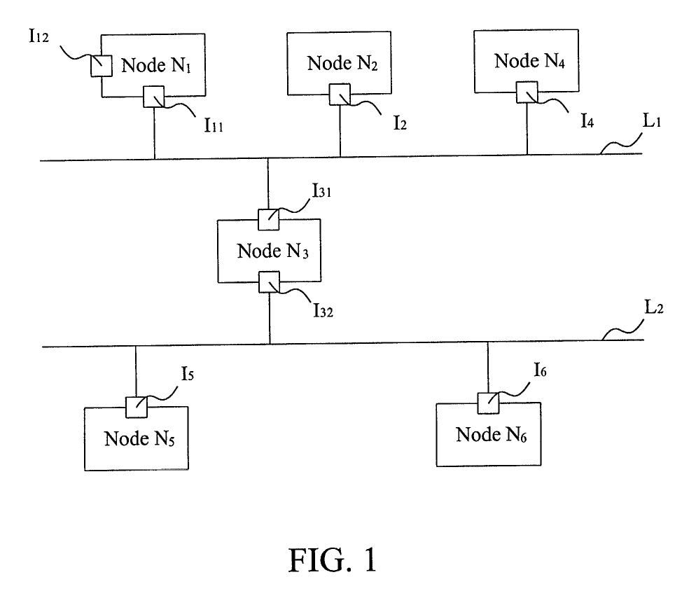

With reference to FIG. 1, there is shown a schematic drawing of a network topology simulated by software according to the invention. The topology is implemented as a bus topology and comprises links Lᵢ (i from 1 to 2) implemented as a transferring medium for transferring simulation frames; nodes Nᵢ (i from 1 to 6) in the network; and network interfaces Iᵢ (i being one of 11, 12, 2, 31, 32, 4, 5, and 6). One interface Iᵢ is permitted to couple to at most one link Lᵢ in compliance with the only linking requirement about the network interface Iᵢ. Further, one network interface Iᵢ is permitted to belong to at most one node Nᵢ in compliance with the only subordination requirement about network interface Iᵢ. Furthermore, one link Lᵢ may be coupled to at least one network interface Iᵢ or nothing. Moreover, one node Nᵢ can have at least one network interface Iᵢ or nothing. In the embodiment, network interface Iᵢ is implemented as a network adapter, while it is appreciated by those skilled in the art that it may be a modem or port without departing from the scope and spirit of the invention.

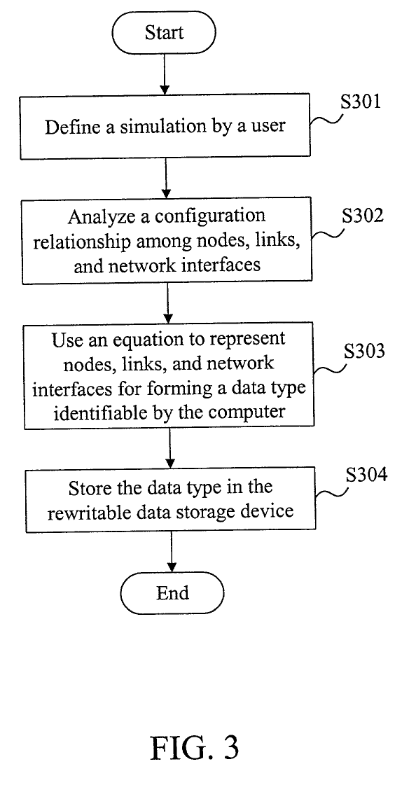

A data conversion procedure is employed to convert network topology of FIG. 1 into data which can be stored in computer. A flow chart illustrating the data conversion procedure is shown in FIG. 3. First, a user defines a simulation (S301) as shown in FIG. 1. Then analyze a configuration relationship among nodes Nᵢ, links Lᵢ, and network interfaces Iᵢ (S302). In FIG. 1, there are provided two links Lᵢ, six nodes Nᵢ, and eight network interfaces Iᵢ. Next, mathematical sets are employed to represent nodes Nᵢ, links Lᵢ, and network interfaces Iᵢ so as to form a data type identifiable by the computer (S303). In the case a set theorem of mathematics is employed to modualize the relationship of links Lᵢ, nodes Nᵢ, and network interfaces Iᵢ shown in FIG. 1. Hence, links Lᵢ and nodes Nᵢ may be represented as follows:

L₁={I₁₁, I₂, I₃₁, I₄},

L₂={I₃₂, I₅, I₆},

N₁={I₁₁, I₁₂},

N₂={I₂},

N₃={I₃₁, I₃₂},

N₄={I₄},

N₅={I₅}, and

N₆={I₆}.

The data type obtained from above simulation is stored in the rewritable data storage device (S304). Also, the rewritable data storage device can be provided in respective computers. In the case, the link Lᵢ is defined to have a unique ID (e.g., link_id) for uniquely identifying a specific link Lᵢ by the rewritable data storage device. Note that the link_id may be a string of characters. The network interface Iᵢ has a unique ID (e.g., interface_id) for identifying a specific network interface Iᵢ. Note that the interface_id is a value having a fixed bit representing an address of medium access control layer of the network interface Iᵢ. Also, any two or more network interfaces Iᵢ coupled to the same link Lᵢ are not allowed to have the same interface_id in compliance with the only identification requirement about the network interface Iᵢ on link Lᵢ. Similarly, any two or more network interfaces Iᵢ coupled to the same node Nᵢ are not allowed to have the same interface_id in compliance with the only identification requirement about the network interface Iᵢ on node Nᵢ.

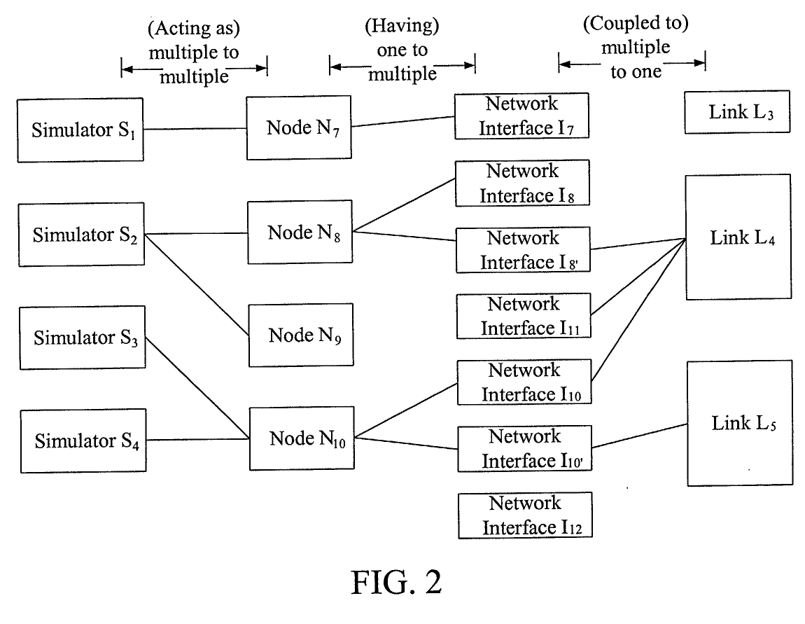

With reference to FIG. 2, there is shown a schematic diagram depicting possible relationship between elements of the rewritable data storage device. As shown, each block represents an element and each line connecting two blocks represents a relationship therebetween. The relationship can be “acting as”, “having”, “belong to”, or “coupled to”.

The invention employs a computer-played simulator procedure to cause a computer to retrieve contents of the rewritable data storage device and follow a logic operation based on the contents, so as to act as a simulator Sᵢ (i=1, 2, 3, or 4). Simulator Sᵢ is typically a process of the operating system and acts as nodes Nᵢ. One simulator Sᵢ can act as one or more nodes Nᵢ. Also, one node Nᵢ can act as one or more simulators Sᵢ. Preferably, for the sake of design, one simulator Sᵢ acts as one node Nᵢ having the lowest complexity.

In the embodiment, simulator Sᵢ defines a protocol as UDP (User Datagram Protocol) of TCP/IP. A process in each operating system is implemented as a simulator Sᵢ for monitoring an UDP port of IP address. In a specific simulation, simulator Sᵢ can only act as one node Nᵢ. Also, each simulator Sᵢ has to transmit or receive simulation frames via UDP.

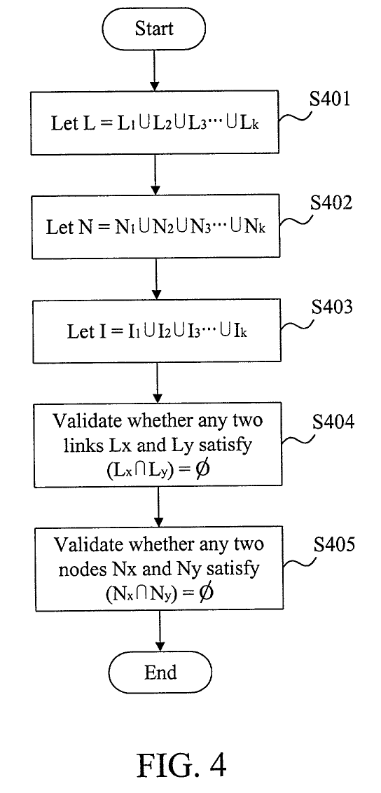

Based on the data conversion procedure, the rewritable data storage device may distribute data into respective computers. Hence, it is important to validate whether the distributed data complies with the original topology. FIG. 4 is a flow chart illustrating a first validation procedure for validating an integrity of the network configuration. In the first validation procedure, R, L, N, I and S represent the rewritable data storage device, all links Lᵢ represented by R, all nodes Nᵢ represented by R, all network interfaces Iᵢ represented by R, and all simulators Sᵢ executed by R, respectively. Further, data of the rewritable data storage device is distributed into k computers and represented as R₁, R₂, R₃, . . . , and Rₖ, wherein R₁={L₁, N₁, I₁, S₁}, R₂={L₂, N₂, I₂, S₂}, . . . , Rₖ={Lₖ, Nₖ, Iₖ, Sₖ}.

First, let L=L₁∪L₂∪L₃ . . . •Lₖ (S401); N=N₁∪N₂∪N₃ . . . •Nₖ (S402); and I=I₁∪I₂∪I₃ . . . ∪Iₖ (S403). Then, it is validated whether any two links Lₓ and L_{y} in the rewritable data storage device satisfy the equation (Lₓ∩L_{y})=Ø (S404). If it is true, it means that it complies with the only linking requirement about the network interface Iᵢ. Next, it is validated whether any two nodes Nₓ and N_{y} therein satisfy the equation (Nₓ∩N_{y})=Ø (S405). If it is true, it means that it complies with the only subordination requirement about the network interface Iᵢ. Note that the first validation procedure is also applicable to a validation of data in a non-distributive rewritable data storage device as long as k has a value of one.

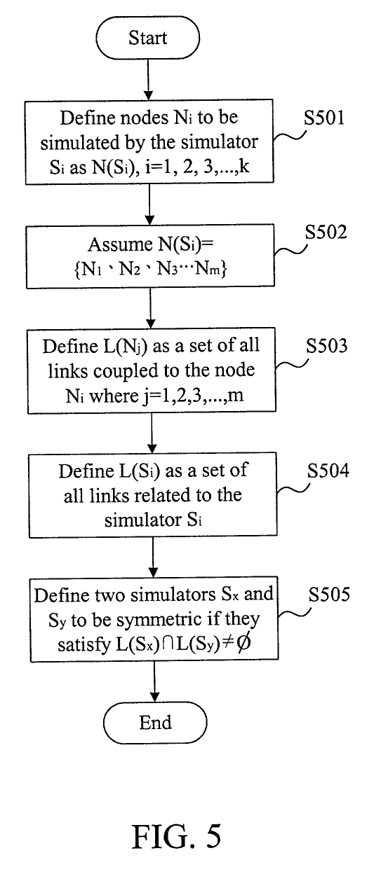

In addition to validate the integrity of topology, it is still required to validate a symmetry of nodes Nᵢ in the rewritable data storage device in order to determine whether the simulator Sᵢ participating in the simulation can obtain address information about the simulator Sᵢ with the help of the rewritable data storage device. With reference to FIG. 5, there is shown a flow chart illustrating a second validation procedure according to the invention. The second validation procedure is substantially the same as the first one. For example, the second validation procedure defines k simulators Sᵢ (e.g., S₁, S₂, S₃, . . . , and Sₖ) participating a simulation.

As shown, nodes Nᵢ are first defined to be simulated by a certain simulator Sᵢ as N(Sᵢ), i=1, 2, 3, . . . , k (S501), so as to form a set. Next, let N(Sᵢ)={N₁, N₂, N₃, . . . , Nₘ} (S502). Then, L(Nⱼ) is defined as a set of all links Lᵢ coupled to the node Nᵢ where j=1, 2, 3, . . . , m (S503). Next, L(Sᵢ) is defined as a set of all links Lᵢ related to the simulator Sᵢ (S504), that is, L(Sᵢ)=L(N₁)∪(N₂)∪L(N₃)∪ . . . . L(Nₘ). Then, any two simulators Sₓ and S_{y} are defined to be symmetric if they satisfy L(Sₓ)∩L(S_{y})≠0 (S505). Hence, the simulator Sₓ obtains the complete information of the simulator S_{y} by the rewritable data storage device in the protocol (e.g., address information, UDP port, or the like). Similarly, the simulator S_{y} obtains the complete information of the simulator Sₓ in the protocol by the rewritable data storage device.

A simulation of the invention is completed if the first and second validation procedures are fulfilled. Next, a procedure of simulating communication between nodes Nᵢ is performed based on the completed simulation. First, in the simulation frame, there are defined an ID (e.g., sender_id) for recording a network interface Iᵢ sending the simulation frame, an ID (e.g., destination_id) for recording a network interface Iᵢ desired to receive the network interface Iᵢ, and an ID (e.g., bearing₁₃ link_id) for identifying a link Lᵢ which transports the simulation frame.

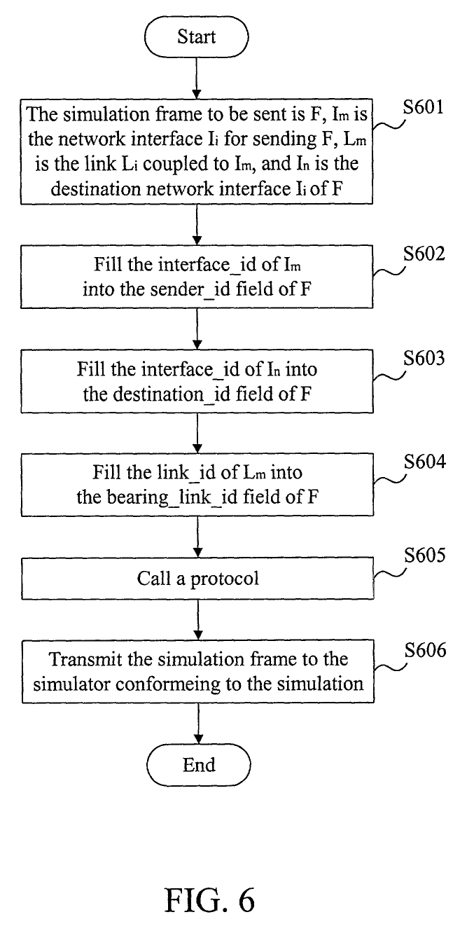

With reference to FIG. 6, there is shown a flow chart illustrating a transmitting simulation frame procedure according to the invention. The simulation frame is defined as a data structure of nodes Nᵢ in communication. The transmitting simulation frame procedure is responsible for sending simulation frames to a simulator Sᵢ for receiving. First, it is assumed that the simulation frame to be sent is F, Iₘ is a network interface Iᵢ for sending F, Lₘ is a link Lᵢ coupled to Iₘ, and Iₙ is a destination network interface Iᵢ of F (S601). Further, the interface_id of Iₘ is filled into the sender_id field of F (S602), the interface_id of Iₙ is filled into the destination_id field of F (S603), and the link_id of Lₘ is filled into the bearing_ink_id field of F (S604). Note that the order of steps S602, S603, and S604 may be altered. Next, a protocol is called for taking the simulation frame as a payload of protocol (S605). Finally, the simulation frame is transmitted to the simulator Sᵢ conforming to the simulation (S606).

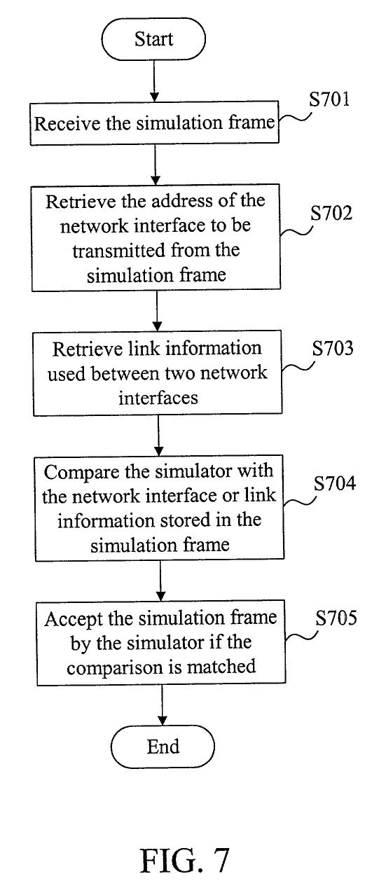

At this time, simulator Sᵢ has to determine whether to process or discard a received simulation frame. In response, a receiving simulation frame procedure has to be performed. With reference to FIG. 7, there is shown a flow chart illustrating the receiving simulation frame procedure. In the receiving simulation frame procedure, I(N) is defined as a set comprising all network interfaces owned by nodes. Also, N(S) and L(S) have to satisfy steps S501, S502, S503, and S504 shown in FIG. 5. Further, I[N(S)] is defined as a set comprising all network interfaces Iᵢ of all nodes Nᵢ simulated by the simulator Sᵢ. The simulator Sᵢ first receives the simulation frame (S701), and next retrieves an address of the network interface Iᵢ to be transmitted from the simulation frame (S702). Such an address is the destination_id stored in the simulation frame as indicated in the transmitting simulation frame procedure. Further, link Lᵢ information used between two network interfaces Iᵢ (S703) is retrieved, i.e., the bearing_link_id stored in the simulation frame. Then, the network interface Iᵢ (or link information) stored in the simulation frame is compared with that in the simulator Sᵢ (S704). The simulation frame can be accepted by the simulator Sᵢ only after the following conditions are satisfied: there exists an interface_id of the network interface Iᵢ in I[N(S)] of simulator Sᵢ wherein the interface_id is equal to the destination_id of the simulation frame, and the link_id of the link Lᵢ coupled to the network interface Iᵢ is equal to the bearing_ink_id of the simulation frame; or the destination_id of the simulator Sᵢ is equal to a specific value (e.g., broadcasting address of LAN (Local Area Network)) validated by a certain simulator Sᵢ, and the bearing_link_id of simulator is in the set of L(S) (S705).

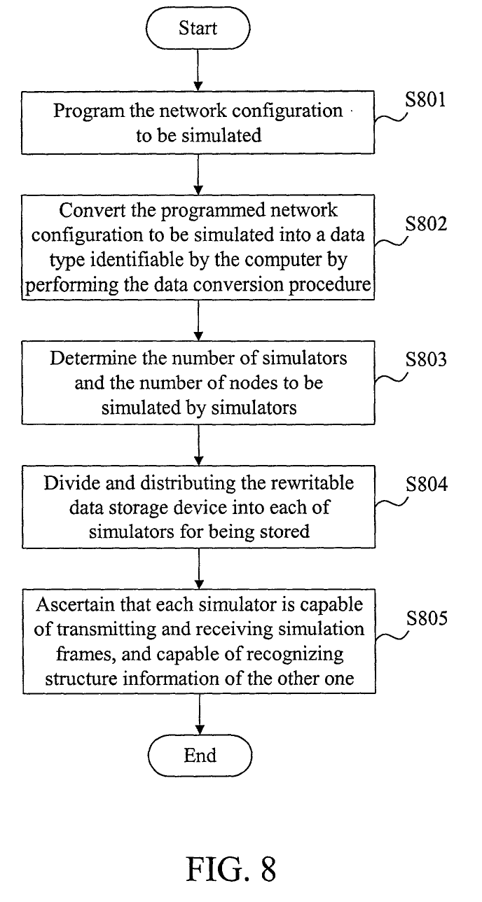

With reference to FIG. 8, there is shown a flow chart illustrating a software simulation network configuration procedure for establishing a network configuration based on above procedures. First, a network configuration is programmed to be simulated (S801). For the sake of programming, it is preferably to schematically draw a network topology to be simulated as that shown in FIG. 1. Next, the programmed network configuration is converted to be simulated into a data type identifiable by the computer by performing the data conversion procedure (S802). Then, a required data field for each element is added in the rewritable data storage device (e.g., data of ID). Thereafter, the number of simulators Sᵢ and the number of nodes Nᵢ to be simulated by simulator Sᵢ are determined (S803). Next, the rewritable data storage device is divided and distributed into each of the simulators Sᵢ for being stored (S804). Finally, it is ascertained that each simulator Sᵢ is capable of transmitting and receiving simulation frames. Also, each simulator Sᵢ is capable of recognizing structure information of the other one (S805).

Although the present invention has been explained in relation to its preferred embodiment, it is to be understood that many other possible modifications and variations can be made without departing from the spirit and scope of the invention as hereinafter claimed.

What is claimed is:

1. A software-based method for simulation of multiple access networks comprising:
a data conversion procedure for converting network configuration information into a data type that is identifiable by a computer and storing the same in a rewritable data storage device which is capable of distributing data into respective computers;
a computer-played simulator procedure for retrieving contents of the rewritable data storage device and following a logic operation based on the contents, so as to act as a simulator for simulating nodes in the network;
a first validation procedure for validating an integrity of the network configuration;
a second validation procedure for validating a symmetry of the network configuration;
a transmitting simulation frame procedure for transmitting simulation frames to a receiving simulator, wherein the simulation frame is implemented as a data structure capable of communicating among nodes;
a receiving simulation frame procedure for determining whether the received simulation frames are valid or not; and
a software simulation network configuration procedure for establishing a network configuration to be simulated based on above procedures.

2. The method as claimed in claim 1, wherein the rewritable data storage device comprises:
at least one node in the network;
at least one link implemented as transferring media for transferring the simulation frames; and
at least one network interface allowed to couple to at most one link and belong to at most one node.

3. The method as claimed in claim 2, wherein the data conversion procedure comprises:
(A) defining a simulation by a user;
(B) analyzing a configuration relationship among the nodes, the links, and the network interfaces;
(C) using mathematical sets to represent the nodes, the links, and the network interfaces so as to form a data type identifiable by the computer; and
(D) storing the data type in the rewritable data storage device.

4. The method as claimed in claim 2, wherein in the first validation procedure, if R, L, N, I and S represent the rewritable data storage device, all links represented by R, all nodes represented by R, all network interfaces represented by R, and all simulators executed by R, respectively, and data of the rewritable data storage device is distributed into k computers and represented as R₁, R₂, R₃, . . . , and Rₖ, wherein R₁={L₁, N₁, I₁, S₁}, R₂={L₂, N₂, I₂, S₂}, . . . , Rₖ={Lₖ, Nₖ, Iₖ, Sₖ}, the first validation procedure comprises the steps of:
(A) letting L=L₁∪L₂∪L₃ . . . ∪Lₖ, N=N₁∪N₂∪N₃ . . . ∪Nₖ, and I=I₁∪I₂∪I₃ . . . ∪Iₖ; and
(B) validating whether any two links Lₓ and L_{y} in the rewritable data storage device satisfy an expression (Lₓ∩L_{y})=Ø, and validating whether any two nodes Nₓ and N_{y} therein satisfy an expression (Nₓ∩N_{y})=Ø.

5. The method as claimed in claim 2, wherein in the second validation procedure, if R, L, N, I and S represent the rewritable data storage device, all links represented by R, all nodes represented by R, all network interfaces represented by R, and all simulators executed by R, respectively, and k simulators represented as S₁, S₂, S₃, . . . , and Sₖ are defined to participate a simulation, the second validation procedure comprises the steps of:
(A) defining nodes to be simulated by a simulator as N(Sᵢ) where i=1, 2, 3, . . . , k; and
(B) assuming N(Sᵢ)={N₁, N₂, N₃, . . . , Nₘ}, defining L(Nⱼ) as a set of all links coupled to the node where j=1, 2, 3, . . . , m, and defining L(Sᵢ) as a set of all links related to the simulator; and
(C) defining any two simulators Sₓ and S_{y} to be symmetric if they satisfy L(Sₓ)∩L(S_{y})≠Ø, and each of the simulators Sₓ and S_{y} obtaining complete information of the other by the rewritable data storage device.

6. The method as claimed in claim 2, wherein the simulation frame has fields for storing an address of its network interface, an address of the network interface to be transmitted, and link information used between any two network interfaces.

7. The method as claimed in claim 6, wherein the transmitting simulation frame procedure comprises the steps of:
(A) calling a protocol; and
(B) using a transmitting function of the protocol to transmit the simulation frame to a simulator conforming to the simulation.

8. The method as claimed in claim 2, wherein the receiving simulation frame procedure comprises:
(A) receiving the simulation frame;
(B) retrieving the address of the network interface to be transmitted from the simulation frame and link information used between any two network interfaces;
(C) comparing the network interface or link information stored in the simulation frame with that in the simulator; and
(D) accepting the simulation frame by the simulator if comparison in (C) is matched.

9. The method as claimed in claim 2, wherein the software simulation network configuration procedure comprises the steps of:
(A) programming the network configuration to be simulated;
(B) converting the programmed network configuration to be simulated into the data type identifiable by the computer by performing the data conversion procedure;
(C) determining number of the simulators and number of nodes to be simulated by the simulators;
(D) dividing and distributing the configuration data in rewritable data storage device into each of simulators for being stored; and
(E) ascertaining that each simulator is capable of transmitting and receiving the simulation frames, and capable of recognizing structure information of the other one.
